(19) United States
(12) Patent Application Publication
(10) Pub. No.: US 2017/0276764 A1
(43) Pub. Date: Sep. 28, 2017

(54) A SYSTEM FOR OUTPUT OF AUDIO AND/OR VISUAL CONTENT

(71) Applicant: Nokia Technologies Oy, Espoo (FI)

(72) Inventors: Miikka Tapani VILERMO, Siuro (FI); Riitta Elina VÄÄNÄNEN, Helsinki (FI); Sampo VESA, Helsinki (FI); Matti Sakari HÄMÄLÄINEN, Lempaala (FI); Arto Tapio PALIN, Akaa (FI); Jukka Pekka REUNAMAKI, Tampere (FI); Juha SALOKANNEL, TAMPERE (FI)

(21) Appl. No.: 15/505,583

(22) PCT Filed: Aug. 29, 2014
(86) PCT No.: PCT/FI2014/050663

§ 371 Date: Feb. 21, 2017

(51) Int. Cl. G01S 5/04; G01S 3/02; H04B 1/38; H04S 7/00; H04W 4/04; H04L 12/28; H04B 1/20

(52) U.S. Cl. CPC G01S 5/04; H04L 12/2816; G01S 3/02; H04B 1/202; H04S 7/302; H04W 4/04; H04B 1/38

(57) ABSTRACT

Output of audio or visual content via local mobile user devices (4a, 4b. 4c, 4d, 4e, 4f), such as a mobile phone and/or a headset, or via output devices (8a, 8b. 8c, 8d, 8e, 8f 8g, 8h), such as a speaker and/or a display, is controlled by a controller (7). The output devices (Sa, 8b. Sc, 8d, 8e, 8f 8g. 8h) are located at different locations within an environment for accommodating users (3a, 3b, 3c, 3d), such as the interior of a car. The controller (7) determines information on a location within the environment of each of the mobile user devices (4a, 4b, 4c, 4d, 4e, 4f) based on wireless signals received from the user devices (4a, 4b, 4c, 4d, 4e, 4f), such as Bluetooth low energy signals, and controls the output of the content based on this.

### FIELD

This specification relates generally to a system for output of audio and/or visual content for experience by users.

### BACKGROUND

It is typical that in a car that there are two loudspeaker pairs, each consisting of a left and right speaker. In this example, one speaker pair is in the front of the car, near the front car seats and often positioned relatively low near the driver's or passenger's knee level, and one speaker pair is in the back. Due to the engine and traffic noise in the car, the back seat passengers don't hear all of the audio produced by the front loudspeakers and vice versa, so the stereo audio which may be played while driving is played both via the front and the back speaker pairs. When audio (e.g. music or radio) is played in a car, the same audio is typically heard via all of the loudspeakers of the car.

### SUMMARY

In embodiments a method comprises establishing a local wireless network connection with one or more mobile user devices; receiving at a receiver one or more wireless signals from the one or more mobile user devices; determining location information for each of the one or more mobile user devices based on the received one or more wireless signals; and based on the determined location information, controlling output of an audio or a visual content via the one or more mobile user devices or via one or more output devices at different locations and configured to output audio or visual content.

Determining location information for each of the one or more mobile user devices may comprise determining an angle of arrival of the one or more wireless signals at the receiver.

The method may comprise receiving the audio or visual content from a first mobile user device of the one or more mobile user devices.

In embodiments where the method comprises receiving the audio or visual content from a first mobile user device of the one or more mobile user devices, controlling output of the audio or visual content may comprise either: outputting the audio or video content via an output device of the one or more output devices configured to output audio or video content to a region indicated by the determined location information for the first mobile user device; or determining a location of a first user associated with the first mobile user device, based on the determined location information for the first mobile user device, and outputting the audio or video content via an output device of the one or more output devices configured to output audio or video content to the determined location of the first user.

The method may comprise receiving the audio or visual content from a receiver or a storage device.

In embodiments where the method comprises receiving the audio or visual content from a receiver or a storage device, controlling output of the audio or visual content may comprise either: in response to determining location information for a first mobile user device of the one or more mobile user devices, sending to the first mobile user device, for outputting by the first mobile user device, the audio or visual content; wherein the audio or visual content is associated with an audio or a visual content being output on an output device of the one or more output devices configured to output audio or video content to a region indicated by the location information for the first mobile user device; or determining a location of a first user associated with the first mobile user device, based on the determined location information for the first mobile user device; and sending to the first mobile user device, for outputting by the first mobile user device, the audio or visual content; wherein the audio or visual content is associated with an audio or a visual content being output on an output device of the one or more output devices configured to output audio or video content to the determined location of the first user.

In embodiments where the method comprises receiving the audio or visual content from a receiver or a storage device, the method may further comprise receiving a first user identification from a first mobile user device of the one or more mobile user devices; receiving the audio or visual content in association with a second user identification; determining an association between the first and second user identifications; and controlling output of the audio or visual content may comprise either: outputting the audio or visual content on an output device of the one or more output devices configured to output audio or visual content to a region indicated by the location information for the first mobile user device; or in response to determining a location of a first user associated with the first mobile user device, based on the determined location information for the first mobile user device, outputting the audio or visual content on an output device of the one or more output devices configured to output audio or visual content to the determined location of the first user.

In embodiments, controlling output of the audio or visual content may comprise either: in response to receiving notification from a first mobile user device of the one or more mobile user devices that it is receiving a phone call, reducing the volume of the output of the audio content by an output device of the one or more output devices configured to output to a region indicated by the location information for the first mobile user device, or stopping the output of the video content by an output device of the one or more output devices configured to output to a region indicated by the location information for the first mobile user device; or determining a location of a first user associated with the first mobile user device, based on the determined location information for the first mobile user device; and in response to receiving notification from the first mobile user device that it is receiving a phone call, reducing the volume of the output of the audio content by an output device of the one or more output devices configured to output to the determined location of the first user, or stopping the output of the video content by an output device of the one or more output devices configured to output to the determined location of the first user.

In the above embodiments the one or more user devices and the one or more output devices may be located within an environment for accommodating users. The environment may comprise an interior of a vehicle, and determining a location of the a user may comprise determining a seating position of the user within the vehicle.

In embodiments where the method comprises receiving the audio or visual content from a first mobile user device of the one or more mobile user devices, and the one or more user devices and the one or more output devices are located within an environment for accommodating users, the environment may comprise an interior of a vehicle and controlling output of the audio or visual content may comprise determining a seating position within the vehicle of a first user associated with the first mobile user device, based on the determined location information for the first mobile user device, and in response to determining that the seating position is a driver's seat of the vehicle, outputting the audio or video content via all of the one or more output devices or via only output devices of the one or more output devices that are configured to output to the occupants of the driver's seat and one or more front passenger seats.

In embodiments where the method comprises receiving the audio or visual content from a first mobile user device of the one or more mobile user devices, and the one or more user devices and the one or more output devices are located within an environment for accommodating users, the one or more mobile user devices comprises a second mobile user device; the environment comprises an interior of a vehicle; and controlling output of the audio or visual content comprises either: in response to determining that the first mobile user device is closer to a driver's seat of the vehicle than the second users device, outputting the audio or video content via all of the one or more output devices; or determining a location within the environment of a first user associated with the first mobile user device based on the determined location information for the first mobile user device, and a second user associated with the second mobile user device, based on the determined location information for the second mobile user device, wherein determining a location within the environment of each of the first and second users comprises determining a seating position of each of the users within the vehicle; and in response to determining that the first user's seating position is closer to a driver's seat of the vehicle than the second user's seating position, outputting the audio or video content via all of the one or more output devices.

In another embodiment, a method comprises establishing a local wireless network connection with a first mobile user device and a second mobile user device; receiving at receiver one or more wireless signals from each of the first and second mobile user devices; determining location information for the first mobile user device based on the one or more wireless signals received from the first mobile user device; determining location information for the second mobile user device based on one or more wireless signals received from the second mobile user device; wherein the one or more user devices and one or more output devices configured to output audio or visual content are located within an interior of a vehicle; and either: in response to determining from the location information for the first and second user devices that the first mobile user device is closer to a driver's seat of the vehicle than the second mobile user device, offering a wireless connection to the first mobile user device instead of or before offering a wireless connection to the second mobile user device; or determining a seat within the interior of the vehicle occupied by a first user associated with the first mobile user device, based on the determined location information for the first mobile user device, and a seat occupied by a second user associated with the second mobile user device, based on the determined location information for the second mobile user device; and in response to determining that the seating position of the first user is closer to a driver's seat than the seating position of second user, offering a wireless connection to the first mobile user device instead of or before offering a wireless connection to the second mobile user device.

Offering a wireless connection to the first mobile user device may comprise offering a wireless connection between one or more other local wireless devices and the first mobile user device.

In the above embodiments, the one or more wireless signals from each of the mobile user devices may comprise at least one radio frequency packet. The mobile user devices may each comprise an array of antennas. Alternatively or additionally, the receiver may comprise an array of antennas, and determining a location of each mobile user device based on the received one or more wireless signals may comprise comparing signals received by the array of antennas.

An embodiment comprises a computer-readable code, or at least one non-transitory computer readable memory medium having the computer readable code stored therein, wherein the computer-readable code, when executed by a processor, causes the processor to perform a method of the above embodiments.

Another embodiment comprises an apparatus, the apparatus having at least one processor and at least one memory having the above computer-readable code stored thereon.

Embodiments comprise an apparatus comprising a receiver configured to receiver one or more wireless signals from one or more local mobile user devices; one or more output devices at different locations and configured to output audio or visual content; at least one processor; and at least one memory having computer-readable code stored thereon which when executed controls the at least one processor to perform the method of any one of the above embodiments.

### BRIEF DESCRIPTION OF THE DRAWINGS

For a more complete understanding of example embodiments of the present invention, reference is now made to the following description taken in connection with the accompanying drawings in which:

FIG. 1 is a schematic diagram of a system which controls output of content to users;

FIG. 2 is a flow diagram illustrating a method by which the system of FIG. 1 operates;

FIG. 3 is a schematic diagram of components of the system of FIG. 1;

FIG. 4 is a flow diagram illustrating the method of FIG. 2 in more detail;

FIG. 5 is a flow diagram illustrating an example of the method of FIG. 4;

FIG. 6 is a flow diagram illustrating an example of the method of FIG. 4;

FIG. 7 is a flow diagram illustrating an example of the method of FIG. 4;

FIG. 8 is a flow diagram illustrating an example of the method of FIG. 4;

FIG. 9 is a flow diagram illustrating an example of the method of FIG. 4;

FIG. 10 is a flow diagram illustrating a method by which the system of FIG. 1 operates;

FIG. 11 is a flow diagram illustrating a method by which the system of FIG. 1 operates;

FIG. 12 is a flow diagram illustrating another example of the method of FIG. 4; and

FIG. 13 is a flow diagram which illustrates updating of the location data for the mobile user devices in the vehicle.

### DETAILED DESCRIPTION OF EXAMPLE EMBODIMENTS

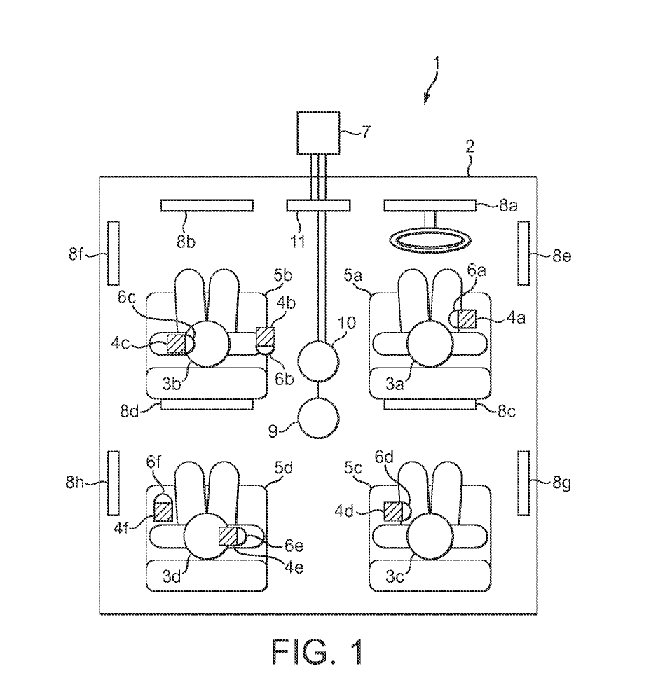

Referring to FIG. 1, a system 1 is illustrated which controls output of audio and visual content within an environment 2 for accommodating users 3a, 3b, 3c, 3d, which in this example comprises the interior of a vehicle such as a car or automobile, based on determined information concerning the location of one or more mobile user devices 4a, 4b, 4c, 4d, 4e, 4f within the environment.

The interior of the car 2 comprises a driver seat 5a, a front passenger seat 5b, a right rear passenger seat 5c and a left rear passenger seat 5d.

Each of the mobile user devices 4a-f comprises a radio tag 6a, 6b, 6c, 6d, 6e, 6f configured to transmit a wireless signal from which the location of the device within the interior of the vehicle 2 can be determined, as described in more detail hereinafter. As explained in more detail hereinafter, the mobile user devices 4a-f may be configured to to receive audio and/or visual content depending on their location within the environment 2, and some of them may also be configured to output content to be experienced by users in the environment 2.

The system 1 comprises a controller 7, output devices 8a, 8b, 8c, 8d, 8e, 8f, 8g, 8h, a receiver 9, a transceiver to and a user interface 11.

The output devices 8a-h are located at different locations within the interior of the vehicle 2 and are configured to output audio or visual content for experience by users.

Output devices 8a-d are display screens, and output devices 8e-h are speakers. Of the output devices 8e-h, each display and speaker is configured to output primarily to a different respective seat 5a-d. For example, display 8b and speaker 8f are configured to output primarily to the front passenger seat 5b. The displays 8c, 8d configured primarily to output to each of the back seats 5c, 5d respectively are head rest mounted displays.

The receiver 9 is configured to receive the wireless signals transmitted by the tags 6a-f of the mobile user devices 4a-f. The receiver 9 is located in the centre of the car ceiling such that it has sufficient visibility of each user seating position 5a-d.

The transceiver to is configured to communicate with the mobile user devices 4a-f via the radio tags 6a-f. The user interface 11 may for example comprise a touch screen. The controller 7 is configured to interface with and control the output devices 8e-h, the receiver 9, the transceiver to and the user interface 11. The receiver 9 and the transceiver to may conveniently be configured as a single unit.

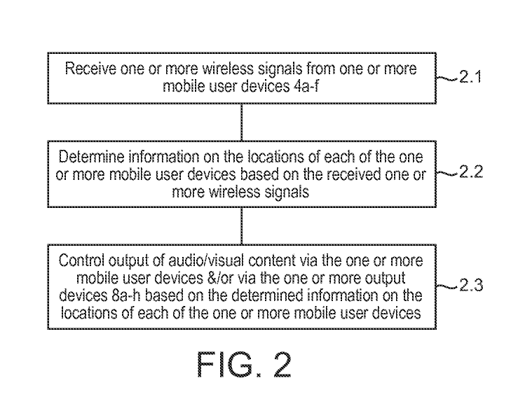

Referring to FIG. 2, a flow diagram illustrating the main steps by which the system 1 operates is shown. At step 2.1, the receiver 9 receives one or more wireless signals from the tags 6a-f of each of the mobile user devices 4a-f. At step 2.2, the controller 7 determines information on a location within the environment 2 of each of the one or more mobile user devices 4a-f based on one or more wireless signals received. At step 2.3, based on the determined information on the location of each of the one or more mobile user devices 4a-f, the controller 7 controls output of an audio and/or a visual content via the one or more mobile user devices 4a-f and/or via the one or more output devices 8e-h.

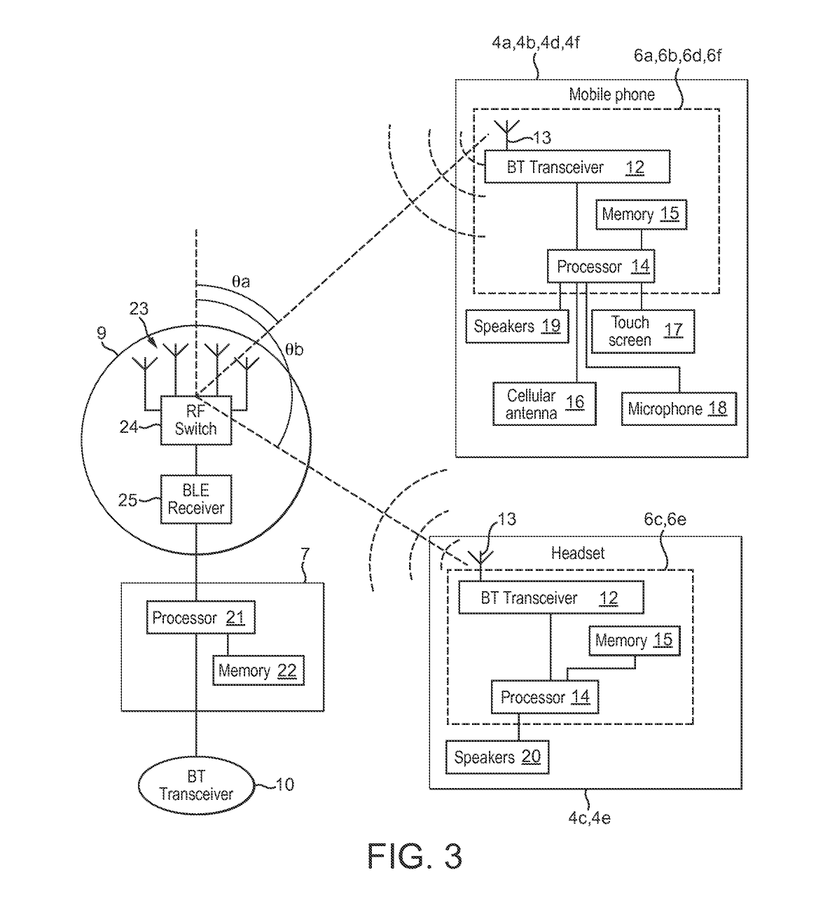

Referring to FIG. 3, the controller 7, receiver 9 and transceiver to are shown in more detail. Also shown in more detail are two of the mobile user devices 4a-f. The system 1 of FIG. 1 provides personalized and automatic use of a car entertainment system by tracking the driver and passenger positions with the aid of an antenna array.

The mobile user devices 4a-f comprise a mobile phone 4a, 4b, 4f and a headset 4c, 4e. Each of the mobile user devices 4a-f has control circuitry. The mobile user devices 4a-f have a Bluetooth (BT) wireless transceiver 12 with an associated antenna 13, together with a processor 14 and memory 15 which perform the function of the tags 6a-f shown in FIG. 1. The processor 14 in association with the memory 15, produces the wireless signals in the form of angle-of-arrival (AoA) packets, each having with a distinctive pattern corresponding to the identity of the mobile user device 4a-f. The transceiver 12 transmits the AoA signal and can also receive command signals from the transceiver to of the car. The tags 6a-f are configured to transmit the AoA signals as Bluetooth LE (low energy) signals. Bluetooth LE is a new wireless communication technology published by the Bluetooth SIG as a component of Bluetooth Core Specification Version 4.0. Bluetooth LE is a lower power, lower complexity, and lower cost wireless communication protocol, designed for applications requiring lower data rates and shorter duty cycles. Inheriting the protocol stack and star topology of classical Bluetooth, Bluetooth LE redefines the physical layer specification, and involves many new features such as a very-low power idle mode, a simple device discovery, and short data packets.

The AoA signals are illustrated in FIG. 3 as wave fronts emanating from the antenna 13 and arriving at the receiver 9 at an angles θa and θb relative to a datum.

The processor 14 and memory 15 are also configured to use the transceiver 12 and antenna 13 to send command signals and other information to the transceiver to of the car, each of which is transmitted in conjunction with information identifying the mobile user device 4a-f.

The mobile phone also includes cellular mobile circuitry with an associated antenna 16 for use with a mobile telephony network, a touch screen 17, a microphone 18 and a speaker 19. The headset comprises speakers 20.

The controller 7 comprises a processor 21 and a memory 22. The memory 22 stores computer-readable code which, when executed by the processor 21, controls the behaviour of the processor 21. Reference herein to configuration of the controller 7 to perform a given act should be interpreted as referring to a configuration of the computer-readable code so as to control the processor 21 to perform the given act. The memory 22 also stores audio and visual content associated within the memory 22 with different user profiles, wherein each user profile relates to a different user 3a-d of the one or more mobile user devices 4a-f.

The receiver 9 comprises a plurality of antennae 23 connected to an RF switch 24, which is in turn connected to a Bluetooth LE receiver 25. The transceiver to comprises a Bluetooth transceiver 10.

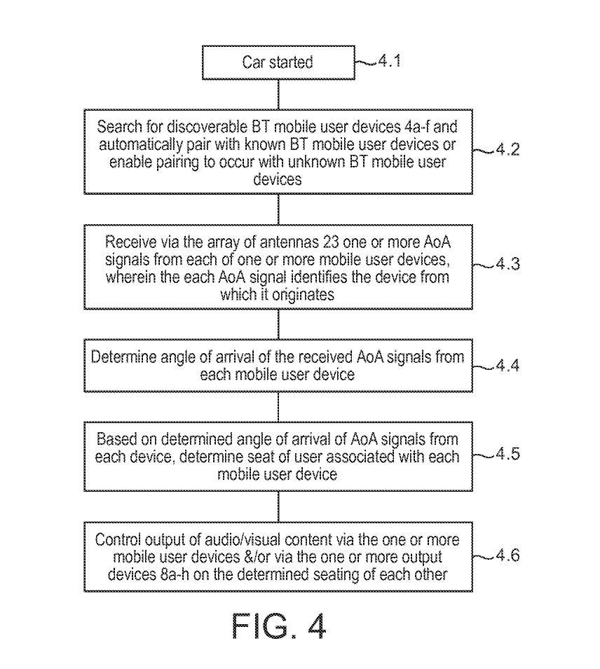

Referring to FIG. 4, the operation of the system 1 is shown in more detail. The car is started at step 4.1. At step 4.2, the controller 7 uses the Bluetooth transceiver to to scan and search for discoverable Bluetooth mobile user devices 4a-f, so as to automatically pair with known Bluetooth mobile user devices 4a-f and enable pairing to occur with unknown Bluetooth mobile user devices 4a-f. This is done according to well known scanning and pairing techniques that are used to establish secure wireless connections between Bluetooth devices. In this way the controller 7, via the transceiver 10, establishes a local wireless network with the one or more mobile user devices 4a-f. This may for example be classified as a wireless local area network (LAN), a wireless personal area network (PAN).

At step 4.3, the controller 7 receives via the plurality of antennas 23 one or more AoA signals from the one or more mobile user devices 4a-f. In more detail, the controller 7 uses the receiver 9 to scan for AoA packets and to execute amplitude and phase sampling during reception of these packets.

At step 4.4, the controller 7 determines the angle of arrival of the AoA signals. In more detail, the controller 7 uses the determined angle and phase samples, along with its own antenna array 23 information, to estimate the direction of arrival of the one or more AoA signals from each mobile user device 4a-f.

At step 4.5, the controller 7 then determines a seat 5a-d of the car occupied by the user 3a-d of each mobile user device 4a-f based on the determined angle of arrival of AoA signals from each user device. In more detail, the controller 7 is configured to determine a seat 5a-d occupied by a user 3a-d from the determined angle of arrival of AoA signals from the user's device based on the fact that users 3a-d are restricted to being located in one of the seats 5a-d of the car, and that a user's mobile devices 4a-f will be in the vicinity of their person (e.g. in their pocket).

At step 4.6, based on the determined seat 5a-d of each user 3a-d of the one or more mobile user devices 4a-f, the controller 7 controls output of an audio and/or a visual content via the one or more mobile user devices and/or via the one or more output devices 8e-h.

For example, the controller 7 can receive content via the transceiver to from a first user's mobile device 4a-f and can send this to one or more of the output devices 8e-h depending on the determined position of the user 3a-d associated with that mobile user device. For instance, the controller 7 may associate the device identification transmitted by the mobile user device 4a-f when sending the content to the transceiver 10 with the device identification communicated in the AoA signals.

Moreover, the controller 7 may play content stored on the memory 22 in association with a user profile of a first user, and this content may be automatically routed to the one or more output devices 8e-h in the vicinity of the mobile user device 4a-f of the first user or in the vicinity of the first user. For example, the controller 7 may associate the user profile with the identification communicated in the AoA signals from the first user's mobile user device 4a-f.

There can also be content stored in association with user profiles on other audio storage/playback devices, such as in the memory 15 of the mobile device 4a-f. As with the content stored on the memory 22 of the controller 7, when content associated with a first user is played by the controller 7, the controller 7 can automatically route it to the one or more output devices 8e-h in the vicinity of the mobile user device 4a-f of the first user or in the vicinity of the first user.

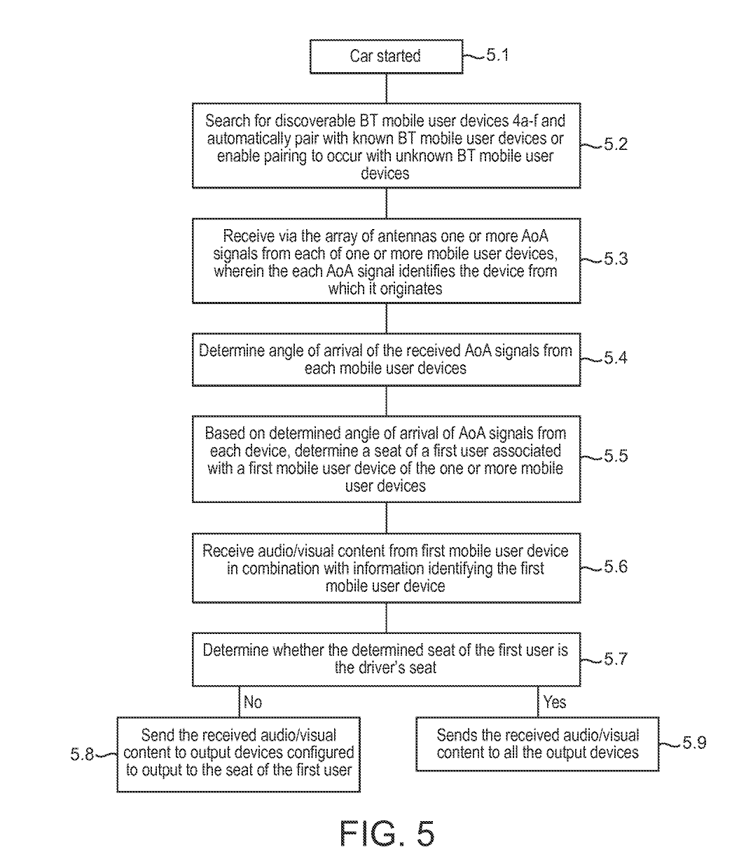

Referring to FIG. 5, an example of the method of FIG. 4 is shown. Steps 5.1 to 5.5 of FIG. 5 correspond to steps 4.1 to 4.5 of FIG. 4.

At step 5.6, the controller 7 receives audio and/or visual content from a first mobile user device, of the one or more mobile user devices 4a-f, in combination with information identifying the first mobile user device. For example, the user of the first mobile user device may have used a user interface 17 of the device to trigger the first device to stream content to the controller 7 via the Bluetooth transceiver 10. For instance, the content may comprises an audio content of a phone call.

At step 5.7, the controller 7 determines whether the determined seat 5a-d of the user of the first user device is the driver's seat 5a.

At step 5.8, in response to determining that the seat 5a-d of the user of the first device is not the driver's seat 5a, the controller 7 sends the received content to only those output devices 8e-h that are configured to output to the user's seat.

For example, the controller 7 may allow music from a mobile device 4d-f belonging to a backseat passenger to be reproduced only via the back loudspeakers.

In another example, a passenger wants to view content on their mobile device 4a-f using a display in the car instead of using the mobile device's small display. The passenger mobile device 4a-f streams the content to the controller 7. The controller 7 recognizes the location of the mobile device using the Bluetooth LE antenna array 23 and a Bluetooth LE tag 6a-f in the device. The controller 7 automatically displays the content using the nearest display (e.g. dashboard mounted or head rest mounted) in the car. Also, audio can be similarly directed to the nearest speaker(s) in the car.

At step 5.9, in response to determining that the seat 5a-d of the user of the first device is the driver's seat 5a, the controller 7 sends the received content to all of the output devices 8e-h. In other words, received audio content is sent to all of the car speakers and/or received visual content is sent to all of the car displays. For example, the controller 7 may automatically connect the mobile user device 4a to an entertainment system of the car so that received audio and/or visual content is sent to all the car output devices 8e-h. For instance, the controller 7 may only allow the driver's phone calls to be reproduced via all of the car speakers.

In another example, the mobile user device 4a of the driver is recognized because its location in the driver's seat 5a can be recognized using the BLE antenna array 23 and Bluetooth LE tag 6a-f. The driver's mobile device 4a is automatically connected to the car entertainment system and audio from that device is reproduced using car speakers.

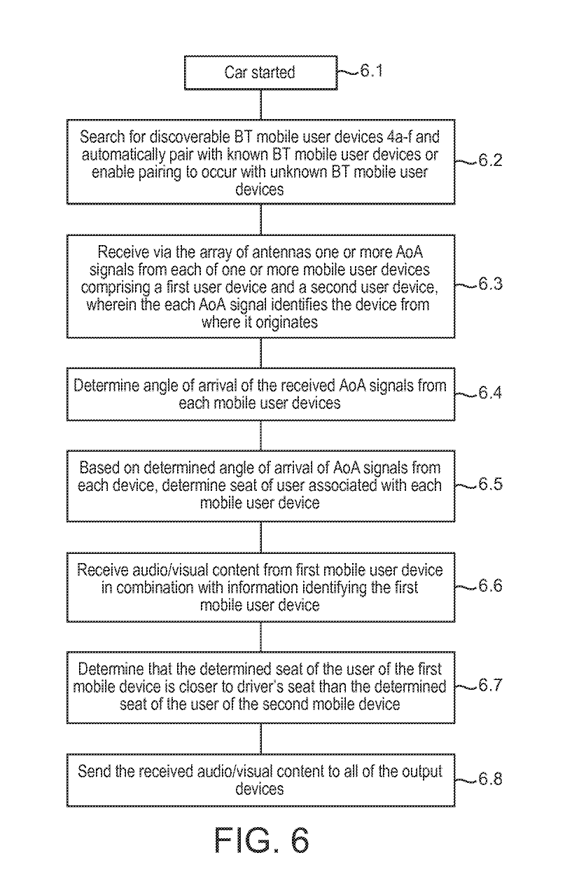

Referring to FIG. 6, an example of the method of FIG. 4 is shown. Steps 6.1 to 6.5 of FIG. 6 correspond to steps 4.1 to 4.5 of FIG. 4, wherein the one or more mobile user devices 4a-f of FIG. 4 comprise a first mobile user device and a second mobile user device.

At step 6.6, the controller 7 receives audio and/or visual content from the first mobile user device in combination with information identifying the first mobile user device.

At step 6.7, the controller 7 determines that the determined seat of the user of the first device is closer to the driver's seat 5a that the determined seat of the user of the second device.

At step 6.8, the controller 7 sends the received content to all of the output devices 8e-h. For example, the controller 7 may connect the first mobile user device to an entertainment system of the car so that audio content from the first mobile user device is sent to the all of the speakers of the car.

In another example, if there is only one phone in the car that is linked to the car audio system, phone calls coming to that phone are reproduced using car speakers. If there are many phones in the car that are linked to the car audio system, phone calls to the phone that is closest to the driver position are reproduced using car speakers.

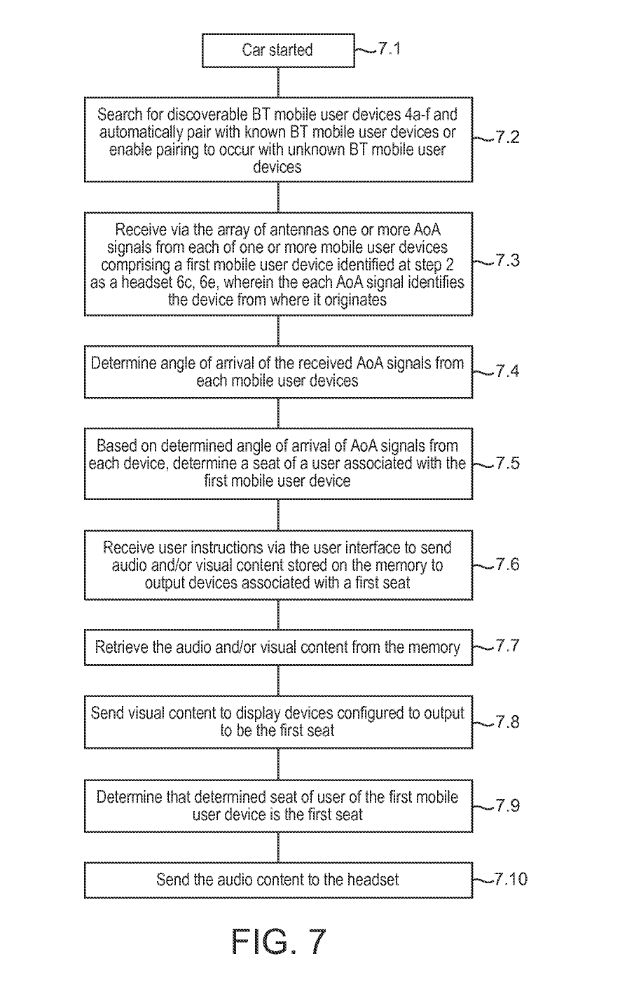

Referring to FIG. 7, an example of the method of FIG. 4 is shown. Steps 7.1 to 7.5 of FIG. 7 correspond to steps 4.1 to 4.5 of FIG. 4, wherein the one or more mobile user devices 4a-f of FIG. 4 comprise a first mobile user device identified by the controller 7 at step 7.2 as being a headset.

At step 7.6, the controller 7 receives user instructions via the user interface 11 to send audio and/or visual content stored on the memory 22 to output devices 8e-h associated with a first seat. At step 7.7, the controller 7 obtains the audio and/or visual content from the memory 22. At step 7.8, the controller 7 sends visual content to the displays associated with the first seat. At step 7.9, the controller 7 determines that the determined seat of the user of the first user device corresponds to the first seat. At step 7.10, the controller 7 sends the audio content to the first user device.

At step 7.8, the controller 7 may alternatively send the audio and/or visual content to the output devices 8e-h configured to output to the first seat. Then, after proceeding through steps 7.9 and 7.10, the controller 7 may cease output of the audio content through the speakers of the first seat.

In an example, a rear seat passenger is using the car entertainment system via one of the head rest mounted displays. The controller 7 can recognize if the passenger has a Bluetooth headset by locating the headset using the Bluetooth LE antenna array 23 and a Bluetooth LE tag 6a-f in the headset. The car entertainment system may then reproduce audio that corresponds to the media displayed in the head rest mounted display to the headset only and not reproduce the audio to any speakers in the car.

As another example, the front displays 8a, 8b may be a multiview display mounted on the dashboard of the car. The multiview display displays different content to the driver and to the front seat passenger. For example, the multiview display may display navigation for the driver and some visual content for the passenger, such as TV or film. Audio related to the content the driver sees is played through car speakers. If the controller 7 finds that the passenger has a Bluetooth headset by locating the headset using the Bluetooth LE antenna array 23 and a Bluetooth LE tag 6a-f in the headset, the audio related to the content the passenger sees from the multiview display is played using the headset.

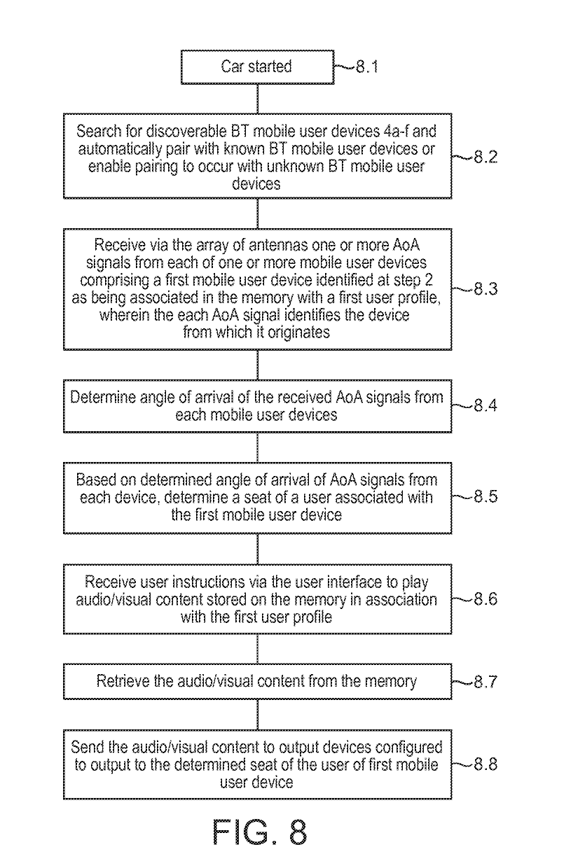

Referring to FIG. 8, an example of the method of FIG. 4 is shown. Steps 8.1 to 8.5 of FIG. 8 correspond to steps 4.1 to 4.5 of FIG. 4, wherein a first user device of the one or more mobile user devices 4a-f is identified by the controller 7 at step 8.2 as being associated in the memory 22 with a first user profile.

At step 8.6, the controller 7 receives user instructions via the user interface 11 to play audio and/or visual content stored on the memory 22 in association with a first user profile. At step 8.7, the controller 7 obtains the audio and/or visual content from the memory 22. At step 8.8, the controller 7 sends the audio and/or visual content to output devices 8e-h configured to output to the determined seat 5a-d of the user of the first device.

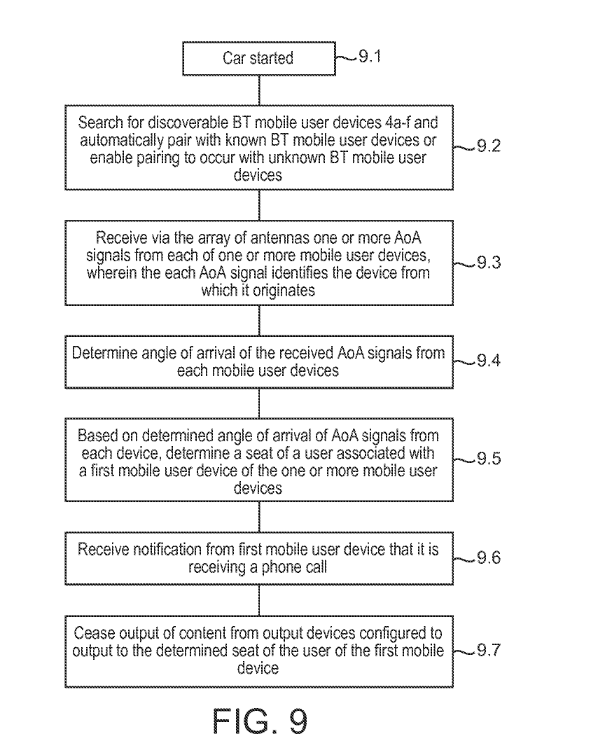

Referring to FIG. 9, an example of the method of FIG. 4 is shown. Steps 9.1 to 9.5 of FIG. 9 correspond to steps 4.1 to 4.5 of FIG. 4, wherein the one or more mobile user devices 4a-f of FIG. 4 comprise a mobile phone as described with reference to FIG. 3.

At step 9.6, the controller 7 receives notification from the mobile phone that it is receiving a phone call. At step 9.7, the controller 7 stops the output of audio and/or visual content from output devices configured to output to the determined seat of the user of the mobile phone.

For example, phones that are not using the car audio system may request the car audio system to silence speakers in their vicinity when they receive a phone call.

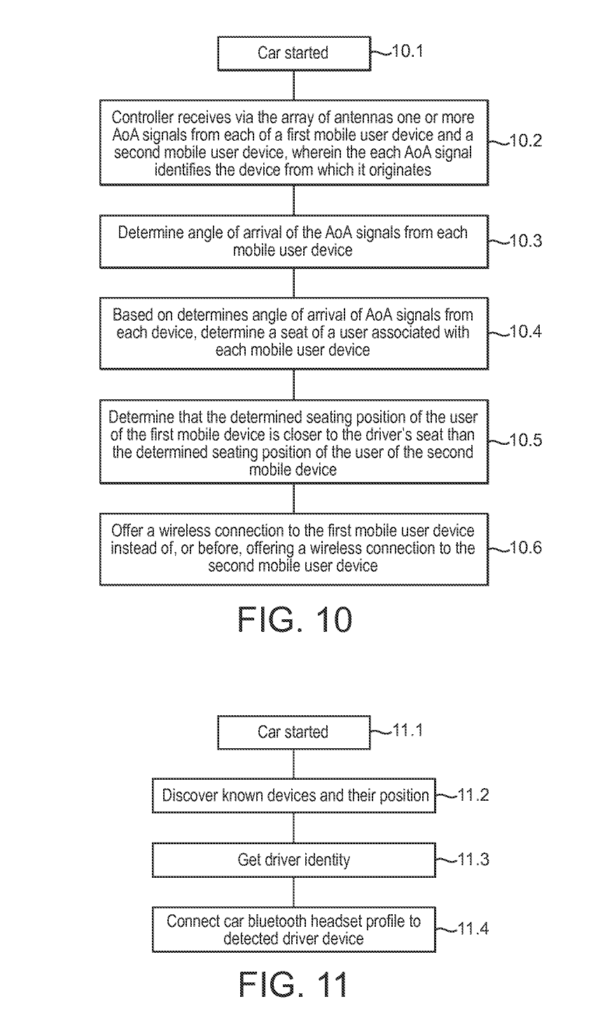

Referring to FIG. 10, an example of the method of FIG. 1 is shown. At step 10.1, the car is started. At step 10.2, the controller 7 receives via the array of antennas 23 one or more AoA signals from each of a first mobile user device and a second mobile user device, wherein the each AoA signal identifies the device from which it originates. At step 10.3, the controller 7 determines the angle of arrival of the received AoA signals from each mobile user device.

At step 10.4, the controller 7 determines the seat 5a-d of the user of the first mobile device and the seat of the user of the second mobile device, based on determined angle of arrival of the AoA signals from each mobile device.

At step 10.5, the controller 7 determines that the determined seating position of the user of the first user device is closer to the driver's seat 5a than the determined seating position of the user of the second device.

At step 10.6, the controller 7 offers a Bluetooth connection to the first user device instead of or before offering a wireless connection to the second mobile user device.

The method of FIG. 10 may additionally include the controller 7 initially searching for discoverable BT devices and automatically pairing with one or more known BT mobile user devices 4a-f or enables pairing to occur with one or more other mobile user devices 4a-f. Moreover, in this case, the offering of a BT connection of step 10.6 may comprise offering a Bluetooth connection between the first user device and the one or more known or other mobile user devices already comprising part of a local wireless network with the controller 7.

With reference to FIG. 11, a further example is illustrated. At step 11.1, the car is started. The controller then, at step 11.2, discovers known mobile user devices, comprising a driver's mobile user device 4a. Moreover, at step 11.2 the controller also detects the positions of the user devices using the methods previously described. The driver identity is determined at step 11.3. After that, at step 11.4 a Bluetooth headset 10o system of the car connects to the estimated driver device 4a, such that audio content of the driver's device is output by the Bluetooth headset system of the car.

The system described facilitates a number of advantages. For example, mobile user mobile devices can be better connected to the car because the users' roles, e.g. whether or not they are the driver and their sitting position in the car, can be detected. Moreover, the driver's device can be recognized and connected to car audio/visual output system differently from other devices. Furthermore, individual passenger devices can be recognized and connected to closest speaker(s) and/or headphone(s) and/or displays in the car.

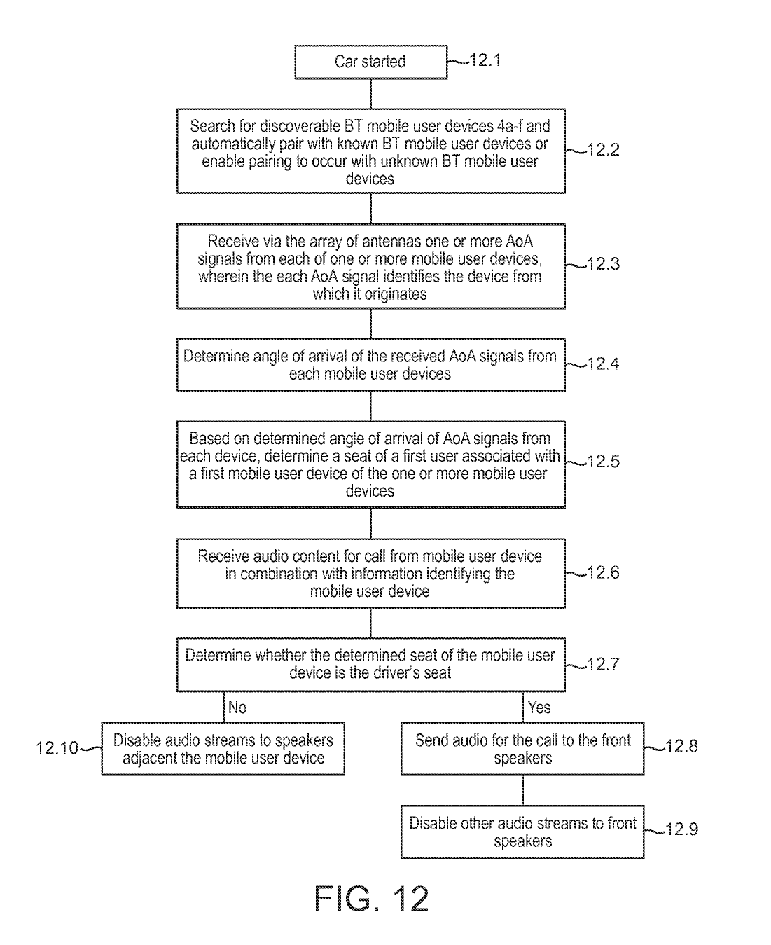

A further example is shown in FIG. 12 in which the speakers 8 are controlled so as enable a mobile telephone call to be conducted by users' mobile phones within the environment 2.

Steps 12.1 to 12.5 of FIG. 12 correspond to steps 4.1 to 4.5 of FIG. 4.

At step 12.6, when the mobile phone 4a, 4b or 4f commences a mobile telephone call, the phone sends data to the controller 7 via a respective one of the tags 6a, 6b or 6f to indicate that the call has commenced to a particular one of the mobile devices associated with a user, and may stream the audio content of the call to the controller 7.

At step 12.7, a determination is made by the controller 7 as to whether the call has been established with the mobile phone of a user located in the driver's seat i.e. phone 4a shown in FIG. 1.

If this is the case, the audio stream for the call is directed to one or more of the front speakers, for example speaker 8a, at step 12.8. Also, any other audio stream currently being sent to at least the or each front speaker is disabled at step 12.9 into other to allow the call to proceed in a hands free mode without the distraction of other audio streams that may be concurrently streamed within the environment 2.

However, if the call is determined to be for another mobile user, e.g. for mobile phone 4f in a passenger seat, which is not the driver's phone, the audio streams to the speaker(s) adjacent the phone 4f e.g. speaker 8f, may be disabled to allow the call to be carried out without distraction, as shown at step 12.10.

Other ways of routing the audio stream for a call for a specific mobile device will be evident and for example the audio stream for the call may be routed to all of the speakers in the vehicle and the current audio/visual content may be disabled if the call is to be shared with all occupants of the vehicle. Other call audio routing and audio stream disabling protocols will be evident to those skilled in the art.

In the examples described with reference to FIGS. 4 to 12, the mobile user devices 4a-4f and their locations in the vehicle 2 are determined when the engine of the vehicle is started. However, there are situations in which the locations of the users may change during a journey without the engine being stopped and restarted. Considering the procedure shown in FIG. 12 by way of example, one of the passengers may take over the role of driver, in which case the vehicle may be stopped with the engine still running, so that the driver and a passenger may swap places in the vehicle. After the change of driver, the location data for the users of the mobile devices held by the controller 7 would be out of date, and in particular the identity of the driver would be incorrect if no action were taken.

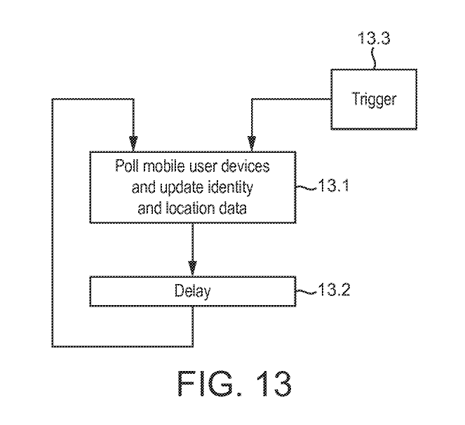

Referring to FIG. 13, this problem may be overcome by the controller 7 causing the receiver 9 and transceiver to to poll the mobile user devices 4a-4f to determine their identity and their current location in the vehicle 2, as shown at step 13.1. This can be performed by Bluetooth scanning techniques and AoA determinations as discussed previously with reference to FIG. 4. The polling may be carried out repeatedly as indicated by the delay shown at step 12.2, or the polling may be triggered by an event as shown at step 13.3, such as the opening of a vehicle door, particularly the driver's door, or in response to events sensed by load sensors in at least one seat of the vehicle.

The process shown in FIG. 13 ensures that data concerning the identity of the driver is kept up to date so that telephone calls to the driver and audio/text and other data supplied to the vicinity of the driver can be controlled to ensure that the driver is not distracted and driving safety is optimised.

The described processes also ensure that any data held for mobile user devices in the vehicle for a previous journey need not be referenced by the controller 7 for use with mobile devices in the vehicle for a subsequent journey, since the described processes ensure that the identity and location data is updated for the subsequent journey.

Due to the masking effect of noise present in a car when driving (e.g. engine and traffic noise), different sounds to different audio content can be output through different loudspeakers configured to output to different regions of the interior of the car without a remarkable disturbance between the different regions of the car interior due to the simultaneously playing different audio contents.

Many alternatives and variations of the embodiments described herein are possible.

For example, although the system 1 has been described in the context of an environment 2 for accommodating one or more users 3a-d comprising the interior of a car, other environments 2 are possible. For example, the environment 2 may be a different type of vehicle, such as a train. Alternatively, the environment 2 may for example be the interior of a building or an outdoor area for use by users.

The methods described with reference to FIGS. 4 to 10 involve determining a seating location 5a-d of a user 3a-d associated with each user device 4a-f based on the determined information on the location of each user device. Moreover, in each of these methods, the determined seating 5a-d location is used by the controller 7 to determine how to control output of content within the interior of the vehicle 2. However, instead of determining a seating 5a-d position of a user 3a-d associated with each user device 4a-f, these methods may alternatively comprise determining other information on the location of a user of each user device 4a-f. For example, the environment 2 may not comprise seats 5a-d, and the methods may involve determining a region within the environment 2 occupied by a user of each user device 4a-f.

Also, not all of the user devices 4 need have a tag 6. For example, when more than one device 4 is associated with a particular user, such as both a mobile phone and a headset, only one of them may be provided with a tag 6 for use in identifying the location of the user.

The determined angle of arrival of AoA signals from user devices 4a-f may comprise more than one angle. For example, the determined angle of arrival may comprise an azimuth angle of arrival and an elevation angle of arrival. In this case, the azimuth angle is the angle of arrival in an azimuth plane relative to a datum, and the elevation angle is the angle of arrival relative to the azimuth plane.

The methods described comprise the controller 7 determining information on location of user devices 4a-f. The methods described with reference to FIGS. 4 to 10 involve determining information on the location of each user device 4a-f comprising the angle of arrival of AoA signals received from each user device. However, the information on the location of each user device 4a-f may comprise information other than, or in addition to, the angle of arrival of the AoA signals. For example, it may comprise information on the proximity of each user device 4a-f to the receiver 9. Moreover, the system 1 may comprise multiple receivers 9 and the information on the location of the user device 4a-f may comprise an angle of arrival determined at each of the multiple receivers 9, for example so as to triangulate the location of the user device within the environment 2.

The methods described with reference to FIGS. 4 to 10 involve determining a location of a user 3a-d associated with each user device 4a-f based on the determined information on the location of each user device. Moreover, in each of these methods, the determined location is used by the controller 7 to determine how to control output of content within the interior of the vehicle 2. However, alternatively, these methods may control output of content, or pairing of devices in the case of the method of FIG. 10, based on the determined information on the location of the user devices 4a-f. This alternative is discussed in more detail below with regard to the methods of FIGS. 4 to 10.

With regard to the method of FIG. 4, step 4.5 may be excluded, and step 4.6 may be based on determined angle of arrival of AoA signals from each user device 4a-f instead of on the determined seating position 5a-d of each user 3a-d.

With regard to FIG. 5, step 5.5 may be excluded and step 5.7 may instead comprise determining whether the determined location of the user device 4a-f is in the vicinity of the driver's seat 5a. For example, the controller 7 may determine whether or not the direction of arrival of the wireless signal from the first user device intersects a region corresponding to the driver's seat 5a. Moreover, step 5.8 may instead comprise sending the audio and/or visual content to output devices 8e-h configured to output content to a region of the environment 2 substantially in line with the angle of arrival of the AoA signals relative to the receiver 9.

With regard to FIG. 6, step 6.5 may be excluded. Moreover, step 6.7 may instead comprise the controller 7 determining, from the determined angle or arrival of the AoA signals from each user device 4a-f, that the direction of the first device relative to the receiver 9 is closer to the direction of the driver's seat 5a relative to the receiver 9 than the direction of the second user device relative to the receiver 9.

With regard to FIG. 7, step 7.5 may be excluded. Moreover, step 7.9 may instead comprise determining, from the determined angle or arrival of the AoA signals from the first user device, that the direction of the first user device relative to the receiver 9 intersects a region of the environment 2 corresponding to the first seat.

With regard to FIG. 8, step 8.5 may be excluded. Moreover, step 8.9 may instead comprise sending the audio and/or visual content to output devices 8e-h configured to output content to a region of the environment 2 substantially in line with the angle of arrival of the AoA signals relative to the receiver 9.

Regarding FIG. 9, step 9.5 may be excluded. Moreover, step 9.7 may instead comprise ceasing output of audio and/or visual content from output devices 8e-h configured to output content to a region of the environment 2 substantially in line with the angle of arrival of the AoA signals relative to the receiver 9.

With reference to Figure to, step 10.4 may be excluded. Furthermore, step 10.5 may instead comprise the controller 7 determining, from the determined angle or arrival of the AoA signals from each user device 4a-f, that the direction of the first device relative to the receiver 9 is closer to the direction of the driver's seat 5a relative to the receiver 9 than the direction of the second user device relative to the receiver 9.

The receiver 9 may be configured to act as a transceiver and to thereby also fulfil the above described functions of the transceiver 10.

Although the mobile user devices 4a-f are described with reference to FIG. 3 as being either mobile phones or headsets, other types of mobile user device are possible. For example, the mobile user devices may comprise a tablet computer or a laptop computer, within which a tag 6a-f has been implemented or installed.

The output devices 8e-h may comprise only audio output devices or only visual output device. Moreover, displays comprising the one or more output devices 8e-h may be touch screen displays and thereby also fulfil one or more functions described herein with reference to the user interface 11.

The processor 14 and memory 15 of the radio tags 6a-f are described with reference to FIG. 3 as being the same processor and memory configured to control other components of the user devices 4a-f, such as the speakers 19, cellular antenna 16 and touch screen 17 of the mobilephone 18. However, the tags 6a-f may have their own dedicated processor and/or memory. For example, the tags 6a-f may be retrofitted to the one or more mobile user devices 4a-f.

The receiver 9 is described as comprising a plurality of antenna. However, alternatively or additionally, the transceiver of the tags may comprise a plurality of antenna. For example, the tags may be a beaconing device transmitting angle-of-departure (AoD) packets and executing antenna switching during the transmission of each packet. The receiver 9 may scan for AoD packets and execute amplitude and phase sampling during reception of the packets. The controller 7 may then utilize the amplitude and phase samples, along with antenna array parameter information, to estimate the AoD of the packet from the beaconing device.

Although Bluetooth LE has been described, the tags 6a-f and receiver 9 may be configured to operate using any suitable type of wireless transmission/reception technology. Suitable types of technology include, but are not limited to Bluetooth Basic Rate/Enhanced Data Rate (BR/EDR) and or WLAN or ZigBee. The use of Bluetooth LE may be particularly useful due to its relatively low energy consumption and because most mobile phones and other portable electronic devices will be capable of communicating using Bluetooth LE technology.

The signals transmitted by the device tags 6a-f may be according to the High Accuracy Indoor Positioning solution for example as described at http://www.in-location-alliance.com.

In above described examples, commands are wirelessly transmitted directly over a wireless link such as Bluetooth LE from the controller 7 to the controlled user devices 4a-f, such as a headset, and from mobile user devices to the controller 7. However, the commands may be transmitted through the intermediary of another device, such as one of the other mobile user devices 4a-f.

In the foregoing, it will be understood that the processors 14, 21 may be any type of processing circuitry. For example, the processing circuitry may be a programmable processor that interprets computer program instructions and processes data. The processing circuitry may include plural programmable processors. Alternatively, the processing circuitry may be, for example, programmable hardware with embedded firmware. The or each processing circuitry or processor may be termed processing means.

The term ‘memory’ when used in this specification is intended to relate primarily to memory comprising both non-volatile memory and volatile memory unless the context implies otherwise, although the term may also cover one or more volatile memories only, one or more non-volatile memories only, or one or more volatile memories and one or more non-volatile memories. Examples of volatile memory include RAM, DRAM, SDRAM etc. Examples of non-volatile memory include ROM, PROM, EEPROM, flash memory, optical storage, magnetic storage, etc.

Reference herein to “computer-readable storage medium”, “computer program product”, “tangibly embodied computer program” etc, or a “processor” or “processing circuit” etc. should be understood to encompass not only computers having differing architectures such as single/multi processor architectures and sequencers/parallel architectures, but also specialised circuits such as field programmable gate arrays FPGA, application specify circuits ASIC, signal processing devices and other devices.

References to computer program, instructions, code etc. should be understood to express software for a programmable processor firmware such as the programmable content of a hardware device as instructions for a processor or configured or configuration settings for a fixed function device, gate array, programmable logic device, etc.

It should be realised that the foregoing embodiments are not to be construed as limiting and that other variations and modifications will be evident to those skilled in the art. Moreover, the disclosure of the present application should be understood to include any novel features or any novel combination of features either explicitly or implicitly disclosed herein or in any generalisation thereof and during prosecution of the present application or of any application derived therefrom, new claims may be formulated to cover any such features and/or combination of such features.

1. A method comprising:
establishing a local wireless network connection with one or more mobile user devices;
receiving at a receiver one or more wireless signals from the one or more mobile user devices;
determining location information for each of the one or more mobile user devices based on the received one or more wireless signals; and
based on the determined location information, controlling output of an audio or a visual content via the one or more mobile user devices or via one or more output devices at different locations and configured to output audio or visual content.

2. The method of claim 1, wherein determining location information for each of the one or more mobile user devices comprises determining an angle of arrival of the one or more wireless signals at the receiver.

3. The method of claim 1, comprising receiving the audio or visual content from a first mobile user device of the one or more mobile user devices.

4. The method of claim 3, wherein the first mobile user device comprises a mobile phone and the content comprises an audio content of a phone call.

5. The method of claim 3, wherein controlling output of the audio or visual content comprises
either:
outputting the audio or video content via an output device of the one or more output devices configured to output audio or video content to a region indicated by the determined location information for the first mobile user device;
or
determining a location of a first user associated with the first mobile user device, based on the determined location information for the first mobile user device, and outputting the audio or video content via an output device of the one or more output devices configured to output audio or video content to the determined location of the first user.

6. The method of claim 1, comprising receiving the audio or visual content from a receiver or a storage device.

7. The method of claim 6, wherein controlling output of the audio or visual content comprises either:
in response to determining location information for a first mobile user device of the one or more mobile user devices, sending to the first mobile user device, for outputting by the first mobile user device, the audio or visual content;
wherein the audio or visual content is associated with an audio or a visual content being output on an output device of the one or more output devices configured to output audio or video content to a region indicated by the location information for the first mobile user device;
or
determining a location of a first user associated with the first mobile user device, based on the determined location information for the first mobile user device; and sending to the first mobile user device, for outputting by the first mobile user device, the audio or visual content;
wherein the audio or visual content is associated with an audio or a visual content being output on an output device of the one or more output devices configured to output audio or video content to the determined location of the first user.

8. The method of claim 6, comprising
receiving a first user identification from a first mobile user device of the one or more mobile user devices;
receiving the audio or visual content in association with a second user identification;
determining an association between the first and second user identifications; and
wherein controlling output of the audio or visual content comprises either:
outputting the audio or visual content on an output device of the one or more output devices configured to output audio or visual content to a region indicated by the location information for the first mobile user device;
or
in response to determining a location of a first user associated with the first mobile user device, based on the determined location information for the first mobile user device, outputting the audio or visual content on an output device of the one or more output devices configured to output audio or visual content to the determined location of the first user.

9. The method of claim 1, wherein controlling output of the audio or visual content comprises either:
in response to receiving notification from a first mobile user device of the one or more mobile user devices that it is receiving a phone call,
reducing the volume of the output of the audio content by an output device of the one or more output devices configured to output to a region indicated by the location information for the first mobile user device, or
stopping the output of the video content by an output device of the one or more output devices configured to output to a region indicated by the location information for the first mobile user device;
or
determining a location of a first user associated with the first mobile user device, based on the determined location information for the first mobile user device; and
in response to receiving notification from the first mobile user device that it is receiving a phone call,
reducing the volume of the output of the audio content by an output device of the one or more output devices configured to output to the determined location of the first user, or
stopping the output of the video content by an output device of the one or more output devices configured to output to the determined location of the first user.

10.-11. (canceled)

12. The method of claim 1, wherein the one or more user devices and the one or more output devices are located within an environment for accommodating users, and wherein the environment comprises an interior of a vehicle and wherein controlling output of the audio or visual content comprises:
determining a seating position within the vehicle of a first user associated with the first mobile user device, based on the determined location information for the first mobile user device, and
in response to determining that the seating position is a driver's seat of the vehicle, outputting the audio or video content via all of the one or more output devices or via only output devices of the one or more output devices that are configured to output to the occupants of the driver's seat and one or more front passenger seats.

13. The method of claim 1, wherein
the one or more mobile user devices comprises a second mobile user device;
wherein the one or more user devices and the one or more output devices are located within an environment for accommodating users, and
the environment comprises an interior of a vehicle; and
controlling output of the audio or visual content comprises
either:
in response to determining that the first mobile user device is closer to a driver's seat of the vehicle than the second users device, outputting the audio or video content via all of the one or more output devices;
or
determining a location within the environment of a first user associated with the first mobile user device based on the determined location information for the first mobile user device, and a second user associated with the second mobile user device, based on the determined location information for the second mobile user device, wherein determining a location within the environment of each of the first and second users comprises determining a seating position of each of the users within the vehicle; and in response to determining that the first user's seating position is closer to a driver's seat of the vehicle than the second user's seating position, outputting the audio or video content via all of the one or more output devices.

14. A method comprising:
establishing a local wireless network connection with a first mobile user device and a second mobile user device;
receiving at a receiver one or more wireless signals from each of the first and second mobile user devices;
determining location information for the first mobile user device based on the one or more wireless signals received from the first mobile user device;
determining location information for the second mobile user device based on one or more wireless signals received from the second mobile user device; wherein
the one or more user devices and one or more output devices configured to output audio or visual content are located within an interior of a vehicle; and
either:
in response to determining from the location information for the first and second user devices that the first mobile user device is closer to a driver's seat of the vehicle than the second mobile user device, offering a wireless connection to the first mobile user device instead of or before offering a wireless connection to the second mobile user device;
or
determining a seat within the interior of the vehicle occupied by a first user associated with the first mobile user device, based on the determined location information for the first mobile user device, and a seat occupied by a second user associated with the second mobile user device, based on the determined location information for the second mobile user device; and in response to determining that the seating position of the first user is closer to a driver's seat than the seating position of second user, offering a wireless connection to the first mobile user device instead of or before offering a wireless connection to the second mobile user device.

15. The method of claim 14, wherein offering a wireless connection to the first mobile user device comprises offering a wireless connection between one or more other local wireless devices and the first mobile user device.

16. The method of claim 14, wherein the one or more wireless signals from each of the mobile user devices comprise at least one radio frequency packet, and wherein either the receiver comprises an array of antennas or mobile user devices each comprises an array of antennas.

17. The method of claim 16, wherein the receiver comprises the array of antennas, and determining a location of each mobile user device based on the received one or more wireless signals comprises comparing signals received by the array of antennas.

18.-34. (canceled)

35. An apparatus comprising
a receiver configured to receiver one or more wireless signals from each of a first mobile user device and a second mobile user device;
one or more output devices at different locations and configured to output audio or visual content;
at least one processor; and
at least one memory having computer-readable code stored thereon which when executed controls the at least one processor to:
interface with the receiver and the one or more output devices;
determine location information for the first mobile user device based on the one or more wireless signals received from the first user device;
determine location information for the second mobile user device based on the one or more wireless signals received from the second user device; wherein
the one or more user devices and the one or more output devices are located within an interior of a vehicle; and
either:
in response to determining from the location information for the first and second user devices that the first mobile user device is closer to a driver's seat of the vehicle than the second mobile user device, offer a wireless connection to the first mobile user device instead of or before offering a wireless connection to the second mobile user device;
or
determine a seat within the interior of the vehicle occupied by a first user associated with the first mobile user device, based on the determined location information for the first mobile user device, and a seat occupied by a second user associated with the second mobile user device, based on the determined location information for the second mobile user device; and in response to determining that the seating position of the first user is closer to a driver's seat than the seating position of second user, offer a wireless connection to the first mobile user device instead of or before offering a wireless connection to the second mobile user device.

36. The apparatus of claim 35, wherein offering a wireless connection to the first mobile user device comprises offering a wireless connection between one or more other local wireless devices and the first mobile user device.

37. The apparatus of claim 35, wherein the one or more wireless signals from each of the mobile user devices comprise at least one radio frequency packet, and wherein either the receiver comprises an array of antennas or mobile user devices each comprises an array of antennas.

38. The apparatus of claim 37, wherein the receiver comprises the array of antennas, and determining a location of each mobile user device based on the received one or more wireless signals comprises comparing signals received by the array of antennas.

39.-40. (canceled)
